(19) United States
(12) Patent Application Publication
(10) Pub. No.: US 2012/0304081 A1
(43) Pub. Date: Nov. 29, 2012

(54) Navigation User Interface in Support of Page-Focused, Touch- or Gesture-based Browsing Experience

(76) Inventors: Mirko Mandic, Seattle, WA (US); Ian H. Kim, Redmond, WA (US); Zachary J. Shallcross, Bothell, WA (US); Eli B. Goldberg, Seattle, WA (US); Aaron M. Butcher, Redmond, WA (US); Rodger W. Benson, Seattle, WA (US); Mary-Lynne Williams, Seattle, WA (US); Jess S. Holbrook, Seattle, WA (US); Jane T. Kim, Seattle, WA (US)

(21) Appl. No.: 13/117,790

(22) Filed: May 27, 2011

(51) Int. Cl. G06F 3/048

(52) U.S. Cl. 715/760

(57) ABSTRACT

Various embodiments provide a web browser user interface that permits users to become more fully immersed in web page content that is displayed by a web browser. The inventive approach emphasizes a “content-over-chrome” approach by providing a navigation user interface model that contextually adapts and modifies the navigation user interface based on a particular current user task. In one or more embodiments, locational modifications are made to place various browser instrumentalities, e.g. navigation instrumentalities, in locations that are selected to enhance the user experience by enabling the user to focus more easily on content-relevant portions of the display screen or device.

### BACKGROUND

Current web browser paradigms have visual and interactive inefficiencies that can degrade the user experience. For example, many web browsers take a “chrome-over-content” approach in which user instrumentalities, such as navigation instrumentalities, as well as other instrumentalities, persistently appear in the chrome at the top of the browser. This takes up screen real estate that could otherwise be dedicated to web page content. In turn, people cannot dedicate their full, undivided attention to web pages. The ubiquitous on-screen presence of these instrumentalities prevents people from getting fully immersed into page content.

In other contexts, web browser user interface layout and sizing are primarily geared toward mouse interaction. Such user interfaces are generally not touch-friendly, which can be problematic for various form factor devices, such as slate and tablet devices. In these contexts, from an ergonomic standpoint, positioning all of the navigation user instrumentalities at top of the screen is not an efficient approach for these and other form factor devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments provide a web browser user interface that permits users to become more fully immersed in web page content that is displayed by a web browser. The inventive approach emphasizes a “content-over-chrome” approach by providing a navigation user interface model that contextually adapts and modifies the navigation user interface based on a particular current user task.

In one or more embodiments, locational modifications are made to place various browser instrumentalities, e.g. navigation instrumentalities, in locations that are selected to enhance the user experience by enabling the user to focus more easily on content-relevant portions of the display screen or device.

Further, one or more embodiments promote efficient user interaction insofar as the navigation user interface's invocation/dismissal model. For example, a gesture-based invocation/dismissal model can be employed in touch-based scenarios to quickly and efficiently enable navigation user interface instrumentalities to be invoked and dismissed.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example computing device in accordance with one or more embodiments.

FIG. 4 is a flow diagram that describes steps in a method in accordance with one or more embodiments.

FIG. 5 illustrates an example computing device in accordance with one or more embodiments.

FIG. 6 is a flow diagram that describes steps in a method in accordance with one or more embodiments.

FIG. 7 illustrates an example computing device in accordance with one or more embodiments.

FIG. 8 is a flow diagram that describes steps in a method in accordance with one or more embodiments.

FIG. 9 illustrates an example computing device that can be utilized to implement various embodiments described herein.

### DETAILED DESCRIPTION

### Overview

Various embodiments provide a web browser user interface that permits users to become more fully immersed in web page content that is displayed by a web browser. The inventive approach emphasizes a “content-over-chrome” approach by providing a navigation user interface model that contextually adapts and modifies the navigation user interface based on a particular current user task.

In one or more embodiments, locational modifications are made to place various browser instrumentalities, e.g. navigation instrumentalities, in locations that are selected to enhance the user experience by enabling the user to focus more easily on content-relevant portions of the display screen or device.

Further, one or more embodiments promote efficient user interaction insofar as the navigation user interface's invocation/dismissal model. For example, a gesture-based invocation/dismissal model can be employed in touch-based scenarios to quickly and efficiently enable navigation user interface instrumentalities to be invoked and dismissed.

In the following discussion, an example environment is first described that is operable to employ the techniques described herein. Example illustrations of the navigation user interface are then described, which may be employed in the example environment, as well as in other environments. Next, a section entitled “Persistence Model” describes a persistence model in accordance with one or more embodiments. Following this, a section entitled “Locational Placement” describes the locational placement of various instrumentalities, including navigational instrumentalities, in accordance with one or more embodiments. Next, a section entitled “Interaction” describes aspects of a user interaction with respect to instrumentalities, including navigational instrumentalities, in accordance with one or more embodiments. Last, a section entitled “Example Device” describes aspects of an example device that can be utilized to implement one or more embodiments.

Example Environment

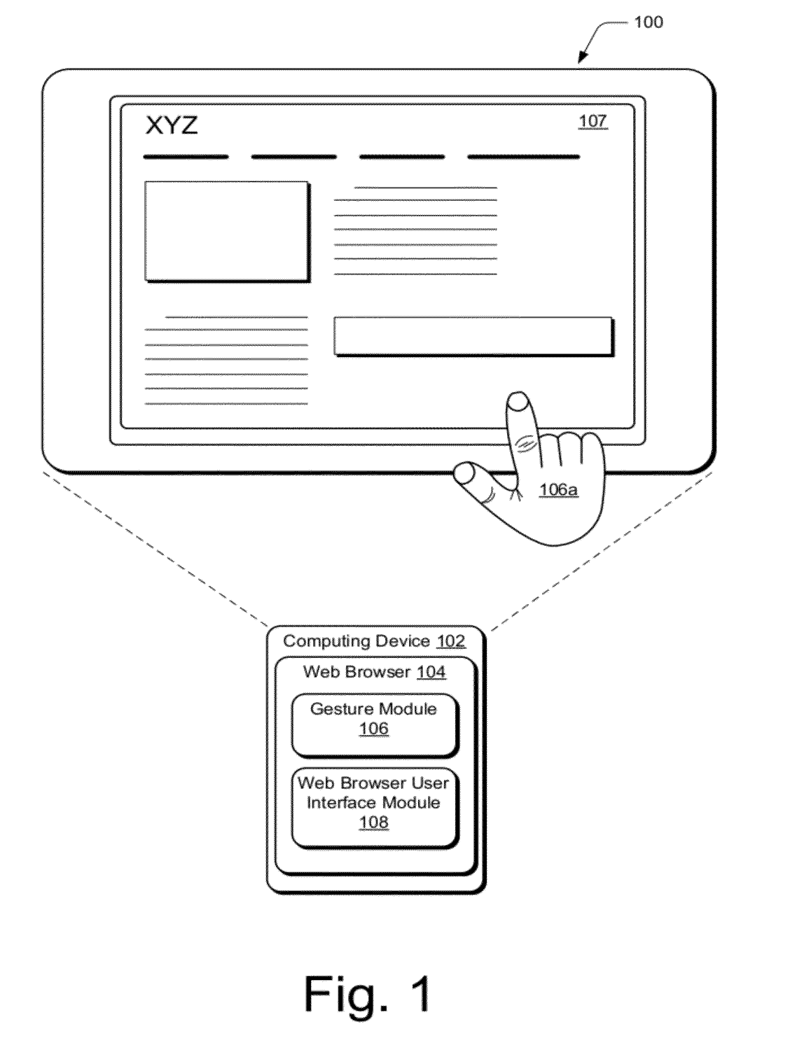

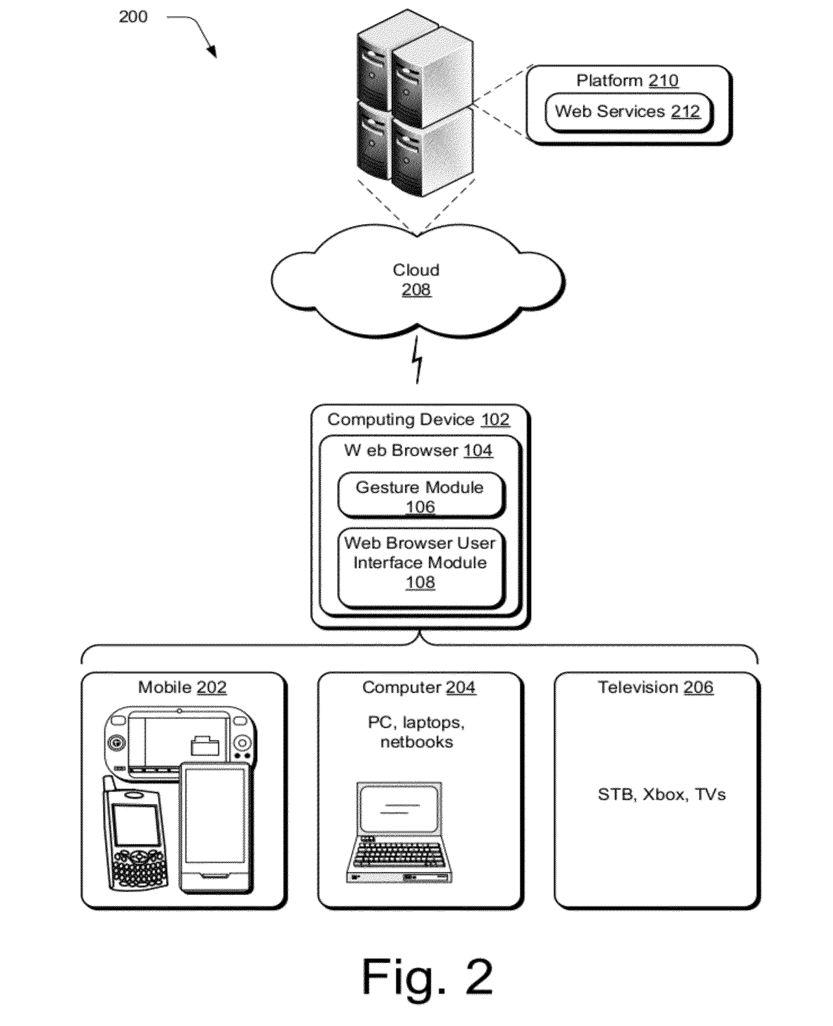

FIG. 1 is an illustration of an environment 100 in an example implementation that is operable to employ the browsing techniques as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. In one or more embodiments, the computing device is embodied as a slate-type or tablet-type form factor device that can typically be held by a user in one hand, and interacted with using the other hand.

Thus, the computing device 102 may range from full resource devices with substantial memory and processor resources (e.g., personal computers, game consoles, slate or tablet-form factor device) to a low-resource device with limited memory and/or processing resources (e.g., traditional set-top boxes, hand-held game consoles). The computing device 102 also includes software that causes the computing device 102 to perform one or more operations as described below.

Computing device 102 includes a web browser 104 that is operational to provide web browsing functionality as described in this document. The web browser can be implemented in connection with any suitable type of hardware, software, firmware or combination thereof. In at least some embodiments, the web browser is implemented in software that resides on some type of tangible, computer-readable medium examples of which are provided below.

Web browser 104 includes or otherwise makes use of, in this example, a gesture module 106 and a web browser user interface module 108.

Gesture module 106 is representative of functionality that can recognize a wide variety of gestures that can be employed in connection with web browsing activities. In at least some embodiments, one or more gestures can be employed in connection with invocation and dismissal of navigation instrumentalities as described in more detail below. The gestures may be recognized by module 106 in a variety of different ways. For example, the gesture module 106 may be configured to recognize a touch input, such as a finger of a user's hand 106a as proximal to display device 107 of the computing device 102 using touch screen functionality. Alternately or additionally, the computing device 102 may be configured to detect and differentiate between a touch input (e.g., provided by one or more fingers of the user's hand 106a) and a stylus input provided by a stylus. The differentiation may be performed in a variety of ways, such as by detecting an amount of the display device 107 that is contacted by the finger of the user's hand 106a versus an amount of the display device 107 that is contacted by the stylus.

Thus, the gesture module 106 may support a variety of different gesture techniques through recognition and leverage of a division between stylus and touch inputs, as well as different types of touch inputs.

The web browser user interface module 108 is configured to provide a web browser user interface that permits users to become more fully immersed in web page content that is displayed by the web browser. The inventive approach emphasizes a “content-over-chrome” approach by providing a navigation user interface model that contextually adapts and modifies the navigation user interface based on a particular current user task, as described below in more detail.

In one or more embodiments, locational modifications are made to place various browser instrumentalities, e.g. navigation instrumentalities and other instrumentalities, in locations that are selected to enhance the user experience by enabling the user to focus more easily on content-relevant portions of the display screen or device. Further, one or more embodiments promote efficient user interaction insofar as the navigation user interface's invocation/dismissal model. For example, as noted above, a gesture-based invocation/dismissal model can be employed in touch-based scenarios to quickly and efficiently enable navigation user interface instrumentalities to be invoked and dismissed.

FIG. 2 illustrates an example system 200 showing the web browser 104 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size or form factor and thus the computing device 102 may be configured as one of these device classes in this example system 200. For instance, the computing device 102 may assume the mobile 202 class of device which includes mobile telephones, music players, game devices, slate-type or tablet-type form factor devices and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

The gesture techniques supported by the gesture module 106 may be detected using touch screen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

Persistence Model

As noted above, various embodiments provide a web browser user interface that permits users to become more fully immersed in web page content that is displayed by a web browser. In the approach about to be described, a “content-over-chrome” approach is taken by providing a navigation user interface model that contextually adapts and modifies the navigation user interface based on a particular current user task.

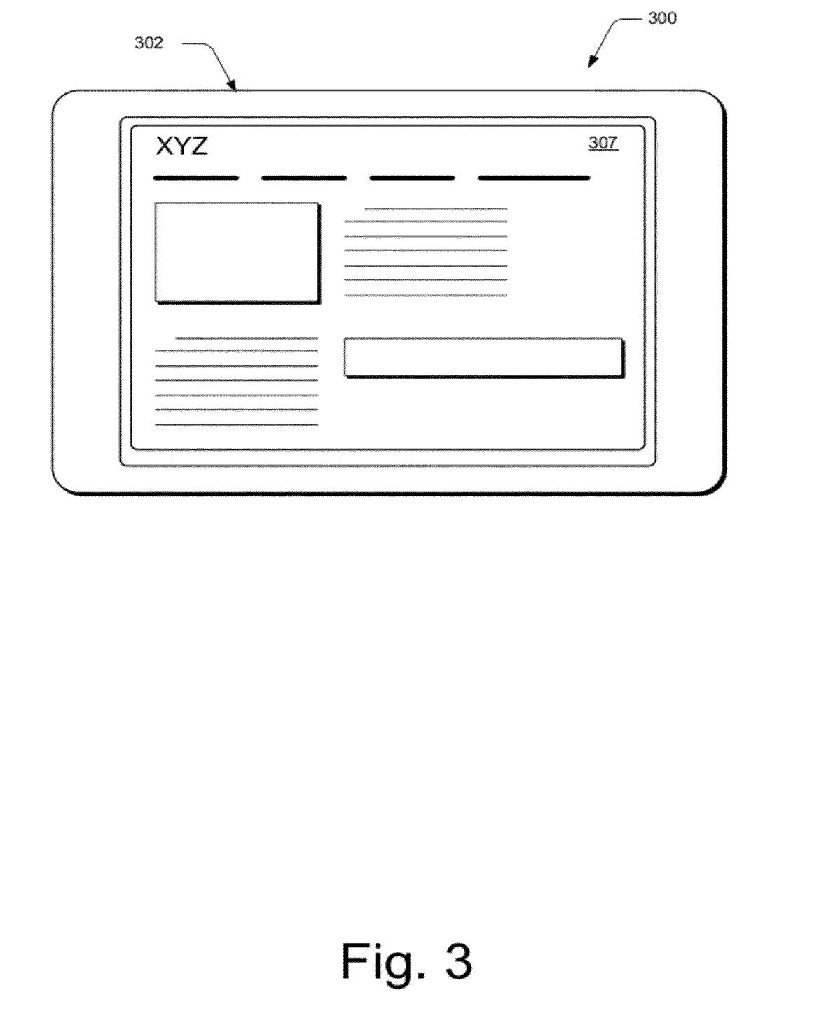

As an example, consider FIG. 3 which illustrates an example environment 300 that includes a computing device 302 having a display device 307. In one or more embodiments, when a webpage is initially loaded, such as the one illustrated in the figure, there are no navigation instrumentalities that are rendered on the display device. Rather, the content of the webpage is presented such that a user is provided a content-focused, edge-to-edge experience where they can focus on the content of the webpage, without their view of the content being obscured by instrumentalities, such as navigation instrumentalities, tab instrumentalities, and the like, that have traditionally been rendered in or around the chrome of the Web browser.

In addition, in one or more embodiments, the navigation instrumentalities as well as other navigation-associated content, such as tabs, can remain in a dismissed stated as a user interacts with the page through activities other than those associated with navigation. For example, a user may pan through a page's content by, for example, using a mouse or through on-screen gestures. While this takes place, the various navigation and other instrumentalities can remain dismissed, thus providing the user with a content-focused, edge-to-edge experience.

In one or more embodiments, various navigation instrumentalities can be invoked, and hence visually presented, in a contextually-relevant manner. The navigation instrumentalities can be presented in any suitable location of the display device, an example of which is provided below. For example, if a user takes an action or performs a task associated with a navigation activity, the navigation instrumentalities as well as other instrumentalities can be invoked and visually presented. As an example, consider the following. Assume that a user is browsing on a particular webpage and selects a link, as by clicking or otherwise touch-tapping on the link. As a consequence, and in view of the fact that the user is conducting a navigation-associated task, navigation instrumentalities as well as other instrumentalities can be visually presented. Specifically, in at least some embodiments, an address bar, and back and forth navigation buttons can be visually presented. Once the user begins to interact with the new webpage, as by panning or otherwise navigating through the page's content, the navigation instrumentalities can be dismissed to again provide the user with an undistracted, edge-to-edge experience.

In one or more embodiments, instrumentalities associated with security can also be presented along with the navigation instrumentalities. Specifically, security icons such as a lock icon, trusted site icon and the like can be presented and dismissed in the manner described above. Alternately or additionally, in at least some embodiments, particularly when a web page may be ascertained to be malicious or otherwise harmful, security warnings can be persisted throughout the user's interaction to reinforce the safety risk.

In one or more embodiments, navigation and other instrumentalities that have been dismissed can be invoked, and hence visually presented, through a gesture. Any suitable type of gesture can be utilized such as a mouse gesture, touch gesture, and the like. In at least some embodiments, a touch gesture in the form of a swipe, such as an edge swipe that originates from off the display device and proceeds onto the display device can be utilized to invoke and cause visual presentation of the navigation and other instrumentalities. Performing the gesture again (or the reverse gesture) can cause the instrumentalities to be dismissed.

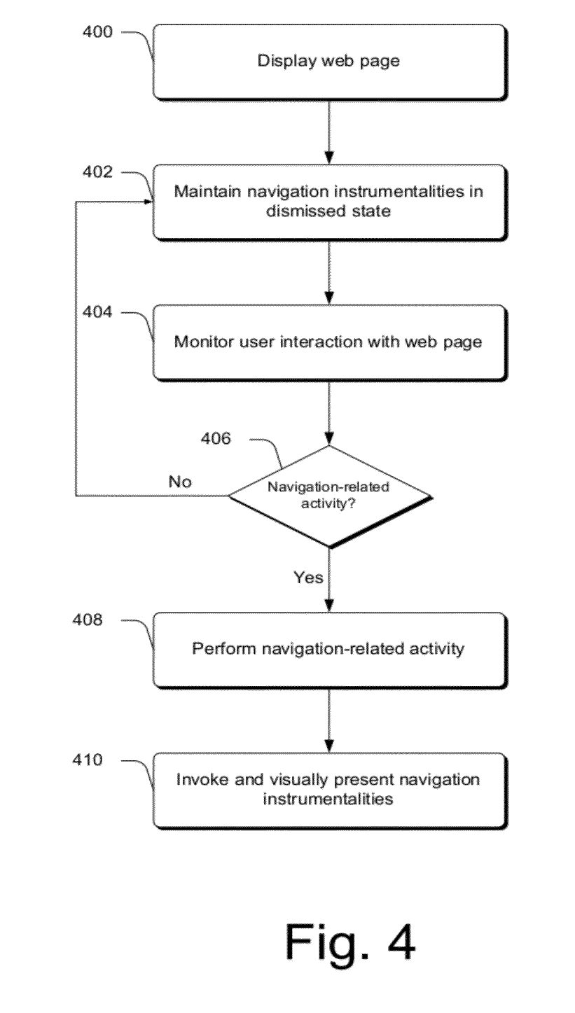

FIG. 4 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 400 displays a webpage. This step can be performed in any suitable way. For example, the webpage can be displayed as part of an initialization process, such as when a browser is initially instantiated and a user's homepage is displayed. Alternately or additionally, display of the webpage can be performed responsive to navigation away from another webpage. Step 402 maintains navigation instrumentalities, and other instrumentalities, in a dismissed state in which the instrumentalities are not viewable. For example, in scenarios where a webpage is displayed as part of an initialization process, the navigation and other instrumentalities can, by default, be maintained in a dismissed state and presented through a specific invocation, such as a swipe gesture. In other scenarios, such as when step 400 is performed responsive to navigation away from another webpage, step 402 can be performed after some type of user activity such as, by way of example and not limitation, a user interacting with a displayed webpage in a non-navigational way. In this instance, navigation instrumentalities might be initially displayed upon a new navigation. However, such instrumentalities can be dismissed following subsequent activities on the particular webpage, such as a user physically touching a displayed page, to provide the edge-to-edge experience mentioned above.

Step 404 monitors user interaction with the webpage. The step can be performed in any suitable way. For example, the step can be performed by monitoring for activities that can cause presentation of the dismissed navigation instrumentalities. These activities can include any suitable navigation-related activities such as, by way of example and not limitation, clicking on a link, opening a new tab page, and the like. If step 406 ascertains that a user activity is not a navigation-related activity, the method can return to step 402. If, on the other hand, step 406 ascertains that the user activity is associated with a navigation-related activity, step 408 can perform the navigation-related activity, as by conducting a navigation, and step 410 can invoke and visually present navigation instrumentalities and/or other instrumentalities, as discussed below in more detail.

As appropriate, the method can then return to step 402, and maintain the displayed navigation and other instrumentalities in a dismissed state responsive to contextually relevant user activities. Such contextually relevant user activities can include, by way of example and not limitation, interacting with the displayed webpage in a non-navigational way.

Having considered embodiments in which navigational and other instrumentalities can be presented and dismissed in a contextually-relevant way, consider now various locational aspects associated with presentation of navigational and other instrumentalities.

Locational Placement

In one or more embodiments, ergonomic efficiencies can be achieved by presenting navigational and other instrumentalities in locations which constitute a departure from traditionally accepted models.

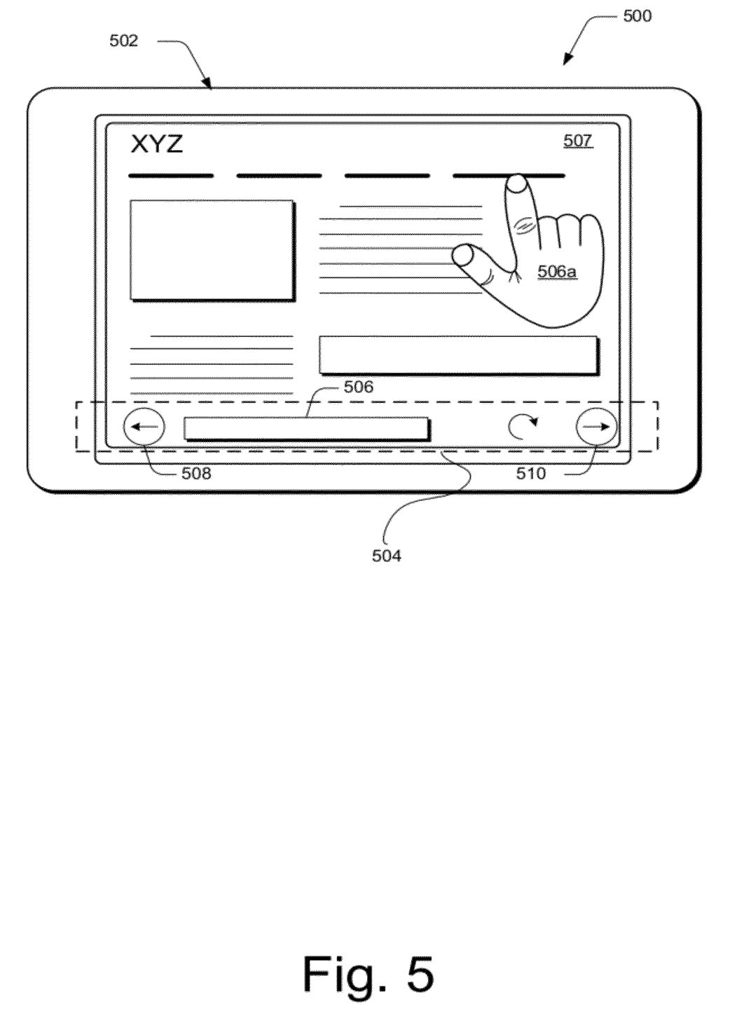

As an example, consider FIG. 5 which illustrates an example environment 500 that includes a computing device 502 in accordance with one or more embodiments. In this example, a user's hand 506a has tap-engaged a link displayed on display device 507. As a consequence of this navigation-related activity, a navigation is performed and, within a region 504 indicated by the dashed line at the bottom of display device 507, various navigation and other instrumentalities have been invoked and visually displayed to constitute a navigation bar. Specifically, in this example, an address bar 506, a backward navigation button 508, and a forward navigation button 510 have been displayed. Notice in this example, that the navigation bar has its backward navigation button 508 located as the leftmost element, and the forward navigation button located as the rightmost element. Locating these elements in their illustrated position has been found to promote a touch-first browsing experience.

The instrumentalities can remain displayed until dismissed as described above.

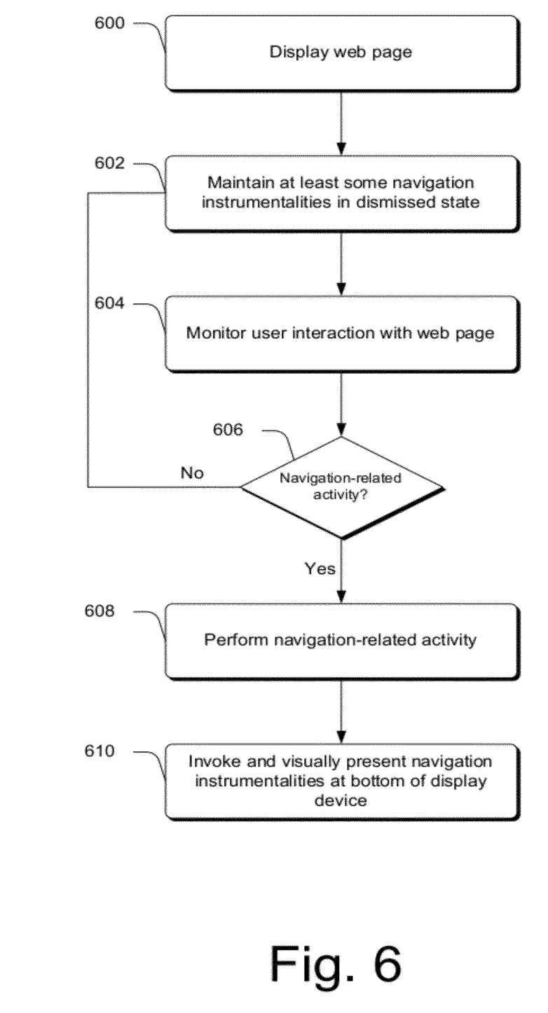

FIG. 6 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 600 displays a webpage. This step can be performed in any suitable way. For example, the webpage can be displayed as part of an initialization process, such as when a browser is initially instantiated and a user's homepage is displayed. Alternately or additionally, display of the webpage can be performed responsive to navigation away from another webpage. Step 602 maintains at least some navigation instrumentalities in a dismissed state. For example, in scenarios where a webpage is displayed as part of an initialization process, the navigation and other instrumentalities can, by default, be maintained in a dismissed state and presented when specifically invoked. Alternately, only the navigation bar might be rendered in this state, and dismissed when the user physically engages the page. In other scenarios, such as when step 600 is performed responsive to navigation away from another webpage, step 602 can be performed after some type of user activities such as, by way of example and not limitation, a user interacting with a displayed webpage in a non-navigational way. In this instance, navigation instrumentalities might be initially displayed upon a new navigation. However, such instrumentalities can be dismissed following subsequent activities on the particular webpage to provide the edge-to-edge experience mentioned above.

Step 604 monitors user interaction with the webpage. This step can be performed in any suitable way. For example, the step can be performed by monitoring for activities that can cause presentation of the dismissed navigation instrumentalities. These activities can include any suitable navigation-related activities such as, by way of example and not limitation, clicking on a link, and the like. If step 606 ascertains that a user activity is not a navigation-related activity, the method can return to step 602. If, on the other hand, step 606 ascertains that the user activity is associated with a navigation-related activity, step 608 can perform the navigation-related activity, as by conducting a navigation, and step 610 can invoke and visually present navigation instrumentalities at the bottom of a corresponding display device.

As appropriate, the method can then return to step 602, and maintain the displayed navigation and other instrumentalities in a dismissed state responsive to contextually relevant user activities. Such contextually relevant user activities can include, by way of example and not limitation, interacting with the displayed webpage in a non-navigational way.

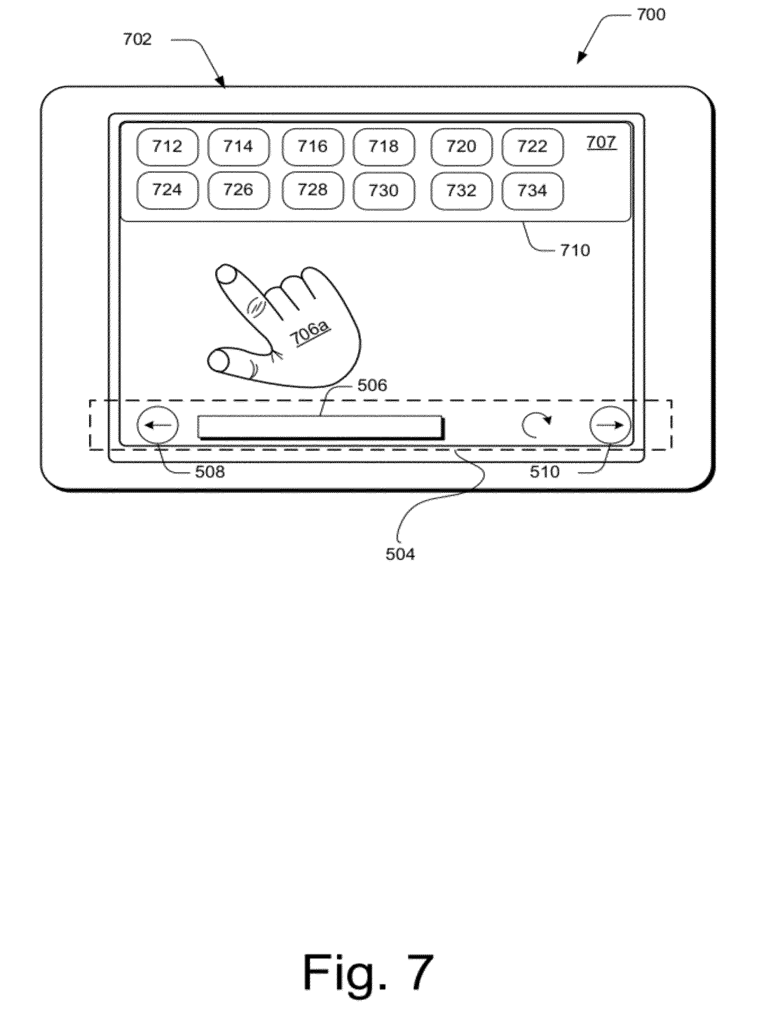

As another example, consider FIG. 7 which illustrates an example environment 700 that includes a computing device 702 in accordance with one or more embodiments. Like numerals from the FIG. 5 example have been utilized to depict like components. In this example, a user's hand 706a has tap-engaged the web page in a manner that has caused a new page to be opened. As a consequence of this navigation-related activity, a new tab is opened and a navigation is performed to the new tab. Notice that region 504 appears at the bottom of display device 707, and various navigation and other instrumentalities have been invoked and visually displayed as described above. In at least some embodiments, because a new tab was opened, a tab band 710 can appear at the top of display device 707 and can include instrumentalities associated with tabs 712-734. In other embodiments, the tabs and associated tab band can be shown when specifically invoked, and not otherwise. The instrumentalities can remain displayed until dismissed as described above.

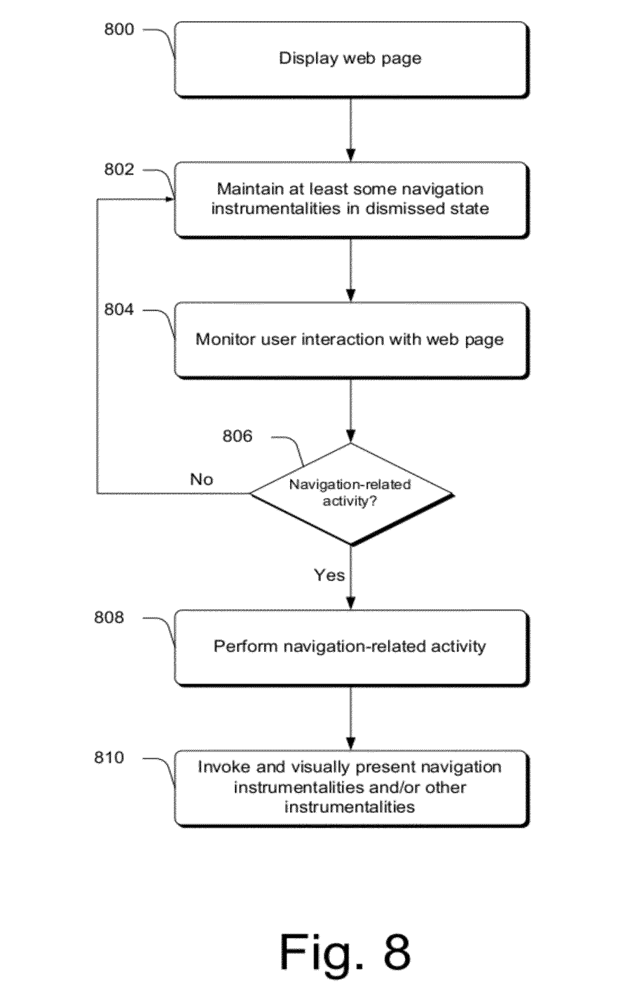

FIG. 8 is a flow diagram that describes steps in a method in accordance with one or more embodiments. The method can be performed in connection with any suitable hardware, software, firmware, or combination thereof. In at least some embodiments, the method can be performed by a suitably-configured web browser, such as the one described above.

Step 800 displays a webpage. This step can be performed in any suitable way. For example, the webpage can be displayed as part of an initialization process, such as when a browser is initially instantiated and a user's homepage is displayed. Alternately or additionally, display of the webpage can be performed responsive to navigation away from another webpage. Step 802 maintains at least some navigation instrumentalities, and other instrumentalities, in a dismissed state. For example, in scenarios where a webpage is displayed as part of an initialization process, the navigation and other instrumentalities can, by default, be maintained in a dismissed state. Alternately, only the navigation bar can be rendered in this state. In other scenarios, such as when step 800 is performed responsive to navigation away from another webpage, step 802 can be performed after some type of user activities such as, by way of example and not limitation, a user interacting with a displayed webpage in a non-navigational way. In this instance, navigation instrumentalities might be initially displayed upon a new navigation. However, such instrumentalities can be dismissed following subsequent activities on the particular webpage to provide the edge-to-edge experience mentioned above.

Step 804 monitors user interaction with the webpage. The step can be performed in any suitable way. For example, the step can be performed by monitoring for activities that can cause presentation of the dismissed navigation and other instrumentalities. These activities can include any suitable navigation-related activities such as, by way of example and not limitation, clicking on a link, opening a new tab page, and the like. If step 806 ascertains that a user activity is not a navigation-related activity, the method can return to step 802. If, on the other hand, step 806 ascertains that the user activity is associated with a navigation-related activity, such as opening a new tab, step 808 can perform the navigation-related activity, as by conducting a navigation or opening a new tab page, and step 810 can invoke and visually present navigation instrumentalities and/or other instrumentalities, on an associated display device. It is to be appreciated and understood that, in at least some embodiments, display of the navigation instrumentalities and tab band can be performed independently of one another. That is, in at least some embodiments, if a user takes a tab-related action, such as causing a new tab to be opened, the tab band alone might be invoked and visually presented in any suitable location including, by way of example and not limitation, at the top of the display device.

As appropriate, the method can then return to step 802, and maintain the displayed navigation and other instrumentalities in a dismissed state responsive to contextually relevant user activities. Such contextually relevant user activities can include, by way of example and not limitation, interacting with the displayed webpage in a non-navigational way.

Having considered various embodiments associated with locational placement of navigational and other instrumentalities, consider now a discussion of various interaction models in accordance with one or more embodiments.

Interaction

In one or more embodiments, when either or both of the navigation instrumentalities or the tab band are hidden from view, each can be individually or collectively invoked and displayed through the use of a suitably-configured gesture. Any suitable gestural input can suffice. For example, in at least some embodiments, the address bar and associated navigational instrumentalities can be invoked by way of a swipe gesture that originates at the bottom of a computing device near the bottom edge of the display device and proceeds onto the display device. The address bar and its associated navigational instrumentalities can be revealed in an animated fashion in which the instrumentalities are seen to gradually emerge from the bottom edge of a computing device, and follow a user's finger until fully displayed. Likewise, a swipe gesture that originates at the top of the computing device near the top of the display screen and proceeds downward can invoke and cause the display of the tab band. Bank and gradually emerge from the top edge of the computed device and follow the user's finger until fully displayed.

In one or more embodiments, a single gesture can be utilized to expose both the bottom-residing navigational instrumentalities, and the top-residing instrumentalities. For example, a bottom swipe, as described above, can reveal both of these instrumentalities. Alternately or additionally, a top swipe, as described above, can reveal both of these instrumentalities. Alternately or additionally, any suitable type of gesture can be used such as, by way of example and not limitation, a two-fingered gesture such as a pinch to reveal the instrumentalities and the like.

In at least some embodiments, duplicating the gesture or performing the opposite gesture can dismiss one or both of the navigation instrumentalities or the tab band instrumentalities.

Example Device

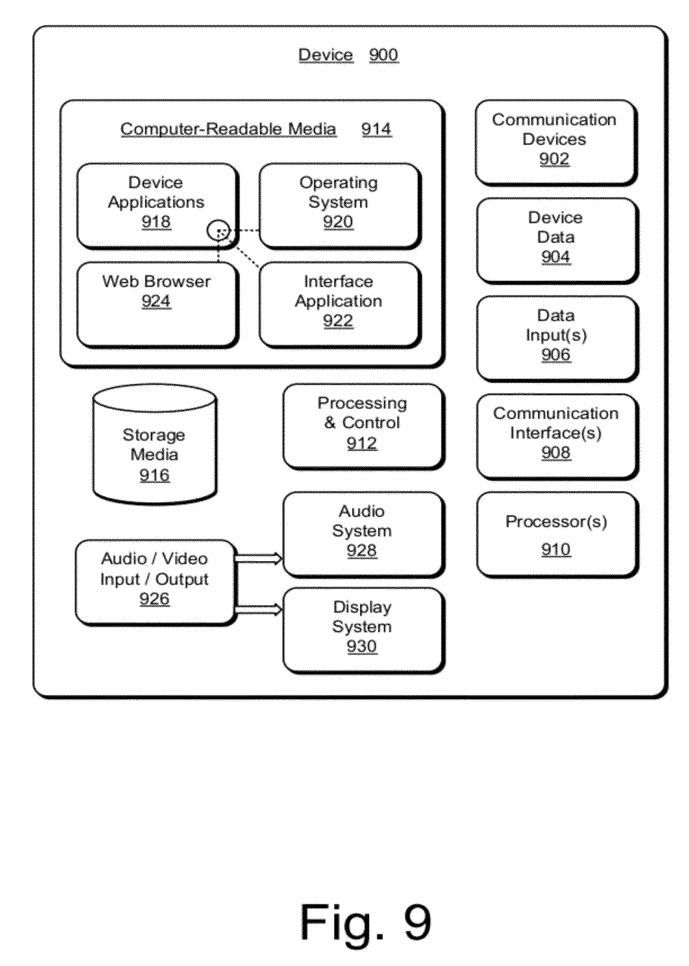

FIG. 9 illustrates various components of an example device 900 that can be implemented as any type of portable and/or computer device as described with reference to FIGS. 1 and 2 to implement embodiments of the gesture techniques described herein. Device 900 includes communication devices 902 that enable wired and/or wireless communication of device data 904 (e.g., received data, data that is being received, data scheduled for broadcast, data packets of the data, etc.). The device data 904 or other device content can include configuration settings of the device, media content stored on the device, and/or information associated with a user of the device. Media content stored on device 900 can include any type of audio, video, and/or image data. Device 900 includes one or more data inputs 906 via which any type of data, media content, and/or inputs can be received, such as user-selectable inputs, messages, music, television media content, recorded video content, and any other type of audio, video, and/or image data received from any content and/or data source.

Device 900 also includes communication interfaces 908 that can be implemented as any one or more of a serial and/or parallel interface, a wireless interface, any type of network interface, a modem, and as any other type of communication interface. The communication interfaces 908 provide a connection and/or communication links between device 900 and a communication network by which other electronic, computing, and communication devices communicate data with device 900.

Device 900 includes one or more processors 910 (e.g., any of microprocessors, controllers, and the like) which process various computer-executable or readable instructions to control the operation of device 900 and to implement the gesture embodiments described above. Alternatively or in addition, device 900 can be implemented with any one or combination of hardware, firmware, or fixed logic circuitry that is implemented in connection with processing and control circuits which are generally identified at 912. Although not shown, device 900 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 900 also includes computer-readable media 914, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 900 can also include a mass storage media device 916.

Computer-readable media 914 provides data storage mechanisms to store the device data 904, as well as various device applications 918 and any other types of information and/or data related to operational aspects of device 900. For example, an operating system 920 can be maintained as a computer application with the computer-readable media 914 and executed on processors 910. The device applications 918 can include a device manager (e.g., a control application, software application, signal processing and control module, code that is native to a particular device, a hardware abstraction layer for a particular device, etc.). The device applications 918 also include any system components or modules to implement embodiments of the gesture techniques described herein. In this example, the device applications 918 include an interface application 922 and a web browser 924 that are shown as software modules and/or computer applications. The web browser 924 is representative of software that is used to provide web browsing functionality, including an interface with a device configured to capture gestures, such as a touch screen, track pad, camera, and so on.

Device 900 also includes an audio and/or video input-output system 926 that provides audio data to an audio system 928 and/or provides video data to a display system 930. The audio system 928 and/or the display system 930 can include any devices that process, display, and/or otherwise render audio, video, and image data. Video signals and audio signals can be communicated from device 900 to an audio device and/or to a display device via an RF (radio frequency) link, S-video link, composite video link, component video link, DVI (digital video interface), analog audio connection, or other similar communication link. In an embodiment, the audio system 928 and/or the display system 930 are implemented as external components to device 900. Alternatively, the audio system 928 and/or the display system 930 are implemented as integrated components of example device 900.

### CONCLUSION

Various embodiments provide a web browser user interface that permits users to become more fully immersed in web page content that is displayed by a web browser. The inventive approach emphasizes a “content-over-chrome” approach by providing a navigation user interface model that contextually adapts and modifies the navigation user interface based on a particular current user task.

In one or more embodiments, locational modifications are made to place various browser instrumentalities, e.g. navigation instrumentalities, in locations that are selected to enhance the user experience by enabling the user to focus more easily on content-relevant portions of the display screen or device.

Further, one or more embodiments promote efficient user interaction insofar as the navigation user interface's invocation/dismissal model. For example, a gesture-based invocation/dismissal model can be employed in touch-based scenarios to quickly and efficiently enable navigation user interface instrumentalities to be invoked and dismissed.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method comprising:
displaying a webpage using a web browser on a computing device;
maintaining at least some navigation instrumentalities in a dismissed state in which the instrumentalities are not viewable;
monitoring user interaction with the webpage;
responsive to ascertaining that a user interaction is associated with a navigation-related activity, performing the navigation-related activity; and
invoking and visually presenting at least navigation instrumentalities.

2. The method of claim 1, wherein said displaying is performed responsive to the Web browser being initially instantiated, and wherein said displaying comprises displaying a navigation bar.

3. The method of claim 1, wherein said displaying comprises displaying navigation instrumentalities using the Web browser; and said maintaining is performed responsive to a non-navigational user interaction with the webpage.

4. The method of claim 1, wherein said presenting at least navigation instrumentalities comprises presenting said instrumentalities at a location other than the top of the Web browser.

5. The method of claim 1, wherein said navigation instrumentalities include at least an address bar.

6. The method of claim 1, wherein said visually presenting comprises visually presenting at least one security instrumentality.

7. One or more computer readable storage media embodying computer readable instructions which, when executed, implement a method comprising:
displaying a webpage using a web browser on a computing device having a display device;
maintaining at least navigation instrumentalities, including an address bar, in a dismissed state in which the instrumentalities are not viewable;
monitoring user interaction with the webpage; and
responsive to ascertaining that a user interaction is associated with a navigation-related activity, invoking and visually presenting the navigation instrumentalities, including the address bar, at the bottom of the display device.

8. The one or more computer readable storage media of claim 7, wherein said displaying is performed responsive to the Web browser being initially instantiated.

9. The one or more computer readable storage media of claim 7, wherein said displaying comprises displaying navigation instrumentalities, including the address bar, using the Web browser; and said maintaining is performed responsive to a non-navigational user interaction with the webpage.

10. The one or more computer readable storage media of claim 7, wherein said invoking and visually presenting further comprises invoking and visually presenting a tab band on the display device responsive to a specific invocation.

11. The one or more computer readable storage media of claim 7, wherein said invoking and visually presenting further comprises invoking and visually presenting a tab band on the display device at a location other than at the bottom of the display device.

12. The one or more computer readable storage media of claim 7, wherein said visually presenting comprises visually presenting at least one security instrumentality.

13. One or more computer-readable storage media embodying computer readable instructions which, when executed, implement a web browser configured to implement a method comprising:
displaying a webpage on a computing device having a display device;
maintaining at least some navigation instrumentalities in a dismissed state in which the instrumentalities are not viewable;
monitoring user interaction with the webpage; and
responsive to ascertaining that a user interaction is associated with a navigation-related activity, invoking and visually presenting one or more of an address bar or a tab band on the display device.

14. The one or more computer-readable storage media of claim 13, wherein said displaying is performed responsive to the Web browser being initially instantiated.

15. The one or more computer-readable storage media of claim 13, wherein said displaying comprises displaying navigation instrumentalities, including the address bar, using the Web browser; and said maintaining is performed responsive to a non-navigational user interaction with the webpage.

16. The one or more computer-readable storage media of claim 13, wherein said invoking and visually presenting further comprises invoking and visually presenting one of the address bar or the tab band at the top of the display device, and the other of the address bar or tab band at the bottom of the display device, the tab band being displayable responsive to a specific invocation.

17. The one or more computer-readable storage media of claim 13, wherein said invoking and visually presenting further comprises invoking and visually presenting one of the address bar or the tab band at the top of the display device, and the other of the address bar or tab band at a location other than at the top of the display device.

18. The one or more computer-readable storage media of claim 13, wherein said invoking and visually presenting further comprises invoking and visually presenting one of the address bar or the tab band at the bottom of the display device, and the other of the address bar or tab band at a location other than at the bottom of the display device.

19. The one or more computer-readable storage media of claim 13, wherein said invoking and visually presenting further comprises invoking and visually presenting the address bar at the bottom of the display device, and the tab band at the top of the display device.

20. The one or more computer-readable storage media of claim 13, wherein said visually presenting comprises visually presenting at least one security instrumentality.
